(19) United States
(12) Patent Application Publication
(10) Pub. No.: US 2025/0171187 A1
(43) Pub. Date: May 29, 2025

(54) METHOD AND APPARATUS FOR TRACKING CONTAINERS IN A FILLING PLANT

(71) Applicant: Krones AG, Neutraubling (DE)

(72) Inventors: Stefan PIANA, Köfering (DE); Alexander HEWICKER, Wörth an der Donau (DE); Anton NIEDERMEIER, Offenstetten (DE)

(21) Appl. No.: 18/961,163

(22) Filed: Nov. 26, 2024

(30) Foreign Application Priority Data
Nov. 28, 2023 (DE) 10 2023 133 223.6

(51) Int. Cl. B65B 57/20; G01N 21/90

(52) U.S. Cl. CPC B65B 57/20; G01N 21/90

(57) ABSTRACT

Described are a method and an apparatus for container tracking in a plant for producing and/or packaging containers and/or for filling the containers, in particular with beverages. The containers are transported through a stationary imaging region of at least one area-imaging sensor, which jointly images several containers in time-staggered images. The images are evaluated electronically and tracking data are extracted that are individually assigned to the containers, which include: identification information for identifying the respective container; and location information about a sequence of locations and associated stay times of the respective container. This makes it possible for the containers to be located and traced independently of relative movements with respect to the transport means used.

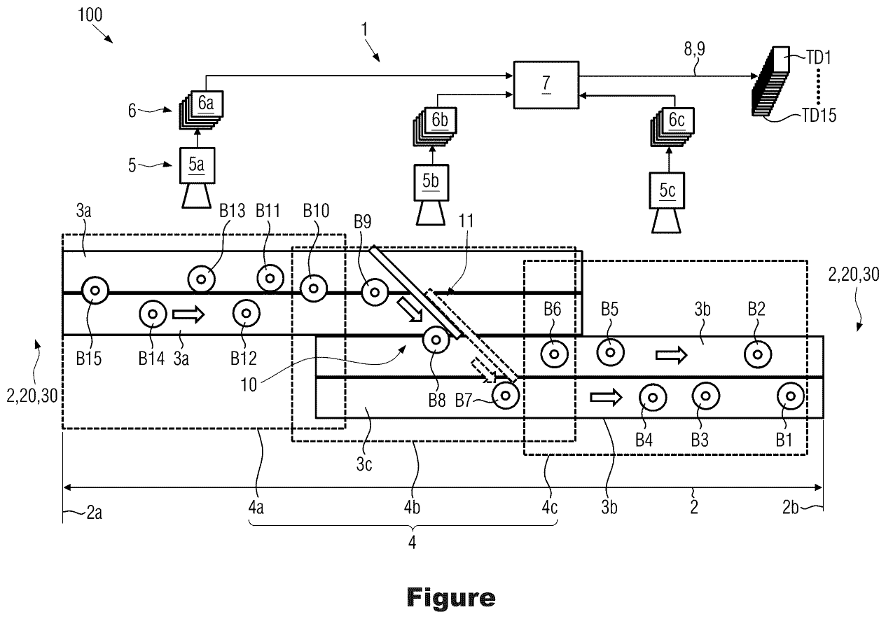

### CROSS REFERENCE TO RELATED APPLICATION

The present application claims priority to German Patent Application No. 10 2023 133 223.6 filed on Nov. 28, 2023. The entire contents of the above-listed application are hereby incorporated by reference for all purposes.

### TECHNICAL FIELD

The disclosure relates to a method and to an apparatus for tracking containers in a filling plant or similar plant for producing and/or packaging the containers.

### BACKGROUND

A method for monitoring and controlling a filling plant and an apparatus for carrying out the method are known from WO2014/170079 A1.

### SUMMARY

As is well known, containers can be moved standing upright in a single lane along a production path on conveyors, such as link chains made of metal or plastic, for the purpose of filling with beverages. Due to their static friction with the conveyor, the containers then move basically synchronously therewith. Tracking of the containers, i.e. their individual localization along the production path, is substantially carried out by the conveyor, by its movement being picked up for example via a rotary pulse encoder on a drive axle and thus determining path increments. However, the required synchronicity of the containers with the conveyor often cannot be sufficiently maintained for the following reasons: vibrations of the conveyor, for example due to polygonal drive wheels, can cause asynchronicity. This can be further exacerbated by, for example, inclines of the conveyor. At curves or transfer points, the containers may be decelerated relative to the conveyor if they come into contact with guide rails.

Such asynchronicities need to be corrected by resynchronization by means of light barriers or similar devices, for example if the respective offset is greater than half the container diameter. This may be necessary several times in succession, depending on the course and length of the transport route in question.

Another disadvantage is that tracking containers as described above is not possible on multi-lane conveyors with amorphous container movement, i.e. in the case of unsorted mass transport where the order of the containers in the product stream can change.

Moreover, post-synchronization results in undesirable technical effort and is also only possible to a limited extent or not at all in certain cases, for example if there is not enough space in the region of several transport lanes arranged next to each other to arrange a reflection light barrier at each one. The sensors used for this purpose may also have to be arranged or adjusted multiple times depending on the format. Moreover, the sensors for resynchronization cannot be operated reliably under certain environmental conditions, for example when there is moisture in the outlet of a filling machine. The sensors also result in additional effort for cleaning and maintaining the respective container tracking section.

There is therefore a need for improvement.

At least one of the aforementioned technical problems is eliminated or at least mitigated by the subject-matter described herein.

The method therefore serves for tracking containers in a filling plant or similar plant for producing and/or packaging containers, for example bottles or cans, and/or for filling the containers, in particular with beverages. The containers are transported, in particular continuously, through a stationary imaging region of at least one area-imaging sensor, which jointly images several containers in time-staggered images. The images are evaluated electronically, whereby tracking data are extracted (calculated) and assigned individually to the containers. The tracking data comprise at least identification information for identifying the respective container and location information concerning a sequence of locations and stay times of the respective container.

The apparatus is configured for tracking containers, in particular bottles or cans, in a filling plant or similar plant for producing and/or packaging the containers and for this purpose comprises: at least one area-imaging sensor with a stationary imaging region for jointly imaging several of the containers during their transport in images offset from one another in time; and an electronic evaluation unit which is configured to extract tracking data of individual containers from the images and to assign them individually to the containers, wherein the tracking data comprise identification information for identifying the respective container and location information about a sequence of locations and associated stay times of the respective container.

The apparatus is, for example, part of a plant for producing and/or packaging containers and/or filling the containers, in particular with beverages, and is in particular part of a filling plant, which in each case comprises: the apparatus according to at least one of the described embodiments and at least one transport means for, in particular, free-standing and/or continuous transport of the containers through the stationary imaging region.

In the plant, the following can be present upstream and/or downstream of the apparatus: another apparatus according to at least one of the described embodiments; a transport means that positively guides the containers; and/or a process unit that positively guides the containers for producing, treating, filling or packaging the containers; a conveyor with conventional synchronous tracking.

Locations of the containers can be specified, for example, by one-dimensional location coordinates (in the case of a sorted single-lane container transport and in the transport direction of the transport means used) or two-dimensional location coordinates (in the case of an unsorted multi-lane container transport and, for example, in the transport direction of the transport means used and transversely thereto), by motion vectors (respective direction and speed of movement) and/or by distances between containers (in the case of a sorted single-lane container transport).

Assigned stay times are, for example, the times when the container images used for extraction are captured, but can also be derived from such times by interpolation or extrapolation. This also applies to the extraction of position data such as location coordinates.

Since no movement data of the transport means used are required for extraction, movements of individual containers along a container tracking section monitored by the area-imaging sensor can be tracked independently of relative movements between the containers and the means transporting the containers through the imaging region. Container tracking is therefore possible without resynchronizing container and transport means movements.

In other words, the described tracking of the containers is based on multiple imaging of the containers during their transport at suitable time intervals by the at least one area-imaging sensor (area sensor), for example a camera, and on identifying the containers as well as on calculating spatially resolved and time-resolved location information for the individual containers, in each case by means of electronic image evaluation.

The location information of several, in particular consecutive, locations and associated stay times of a specific container can in each case be assigned to an individual electronic container identifier at least over the course of a container tracking section to be monitored. In this way, a data set with tracking data is then assigned to each container in a traceable manner, for example in the form of an individual identifier retained along a production path through the plant as well as extracted location coordinates of the respective container and points in time assigned to the location coordinates, which are the times when the images are taken and/or can be derived therefrom by interpolation or extrapolation.

Optionally, the stationary imaging region is assigned to a container tracking section, and the tracking data indicate the identity as well as the locations and stay times of the respective container at least for one entry region and one exit region of the container tracking section and are stored in particular in a traceable manner. It is then at least known in which order the containers enter and exit the container tracking section, in particular the respective times and/or (transfer) locations of the individual containers. This makes possible the individual tracking of the containers even beyond the container tracking section, for example to upstream and/or downstream transport means or process units in which the containers are optionally positively guided, i.e. at fixed transport intervals, and also to other container tracking sections of the type described or conveyors with conventional synchronous tracking.

The tracking data can be stored, for example, in the evaluation unit used or at a central location outside the apparatus described and makes possible individual container tracking even after the production process has ended, for example for the purpose of quality assurance.

Optionally, this is a camera-based tracking, wherein the actual positions of individual containers along a container tracking section are determined cyclically and simultaneously for a large number of containers. Optionally, each container present in the imaging region of the at least one area sensor is detected during each recording cycle, which allows for particularly reliable tracking of the containers with high redundancy.

The at least one area sensor can be configured as a matrix camera (2D camera of conventional design) or as a 3D camera. Image evaluation can be based on basically known methods, such as triangulation, time-of-flight, shape-from-shading and/or stereometry. In principle, the use of at least one line-scan camera would also be conceivable.

The area sensor can be sensitive to ultraviolet, visible and/or infrared light. In principle, other non-contact, imaging area sensors would also be conceivable, for example based on radar, ultrasound or lidar, provided a spatially resolving detection of the transport route to be monitored by container tracking is possible.

The sensors for tracking the containers are configured to work independently of the movement of the respective conveyor that moves the containers during tracking. This means that the participation of existing rotary encoders or similar sensors on the respective conveyor is not required for the method described, but is optionally possible, for example, for a plausibility check of the results.

The described tracking of the containers can also be used to detect different container movements, such as manual removal of containers, an emergency stop, containers toppling and/or having contact with other containers or with plant components which, from a transport point of view, are stationary.

Optionally, the image recording rate of the at least one area sensor is 5 to 40 images per second.

The position data of the individual containers can be identified using basically known, rule-based algorithms, for example on the basis of alpha/beta/gamma filters, Kalman filters and/or sequential Monte Carlo methods. However, image evaluation can also be carried out by means of neural networks that are specifically optimized for image evaluation, such as CNN.

Suitable features for locating the containers in the respective images include, for example, the container caps or, in case of unsealed containers, their mouths. Contour features of the containers or their contents are also conceivable.

Location information can be determined by evaluating several and, in particular, all images in which a specific container appears. The location information can consist of calculating movement vectors of individual containers from image to image. Interpolation makes statements possible about container positions in time intervals between evaluated images. Likewise, future container positions can be predicted by extrapolation, which serves, for example, for recognizing and reliably identifying individual containers in successive images.

On the basis of the container tracking described, inspection sensors on a container tracking section or immediately thereafter can be triggered, for example when containers are at an optimal recording position relative to the inspection sensor. Likewise, actuators for container manipulation, such as discharge systems for individual containers, can be precisely controlled when individual containers are at a discharge position.

The described following of containers is also referred to as tracking. These terms are used synonymously herein. In other words, tracking means the following of individual containers over a specific transport route and/or over a period of time, wherein the respective container is always identified.

### Advantageous Applications Include:

Tracking in the outlet of a can filler, when cans exit an outfeed starwheel at high speed and first slide a variable distance on a conveyor before they are slowed down enough to run synchronously therewith. Arranging an area sensor (e.g. a camera) outside the filler and using an inclined recording perspective makes it possible to place the area sensor outside a region with inappropriately high humidity.
Tracking over complex transport routes with curves, transfer points, guide elements or the like, where otherwise multiple synchronization would be necessary and/or inspection sensors or container manipulators could not be reliably triggered.
Tracking on a height-adjustable filler outlet with an outlet conveyor that operates at different inclines depending on the type of product.
Tracking when transporting containers by means of dynamic pressure, for example in the inlet of a rotary machine having an inlet screw, where the associated conveyor under the containers runs faster than the containers and the inlet screw.
Tracking on multi-lane conveyors with amorphous container stream, for example regardless of whether it is a rigid buffer section or a demand-controlled variable buffer. Containers can overtake each other and can even be pushed against the direction of transport or transversely thereto in the accumulation region. Moreover, tracking is also possible at transitions from single-lane to multi-lane transport, and vice versa.

The container tracking described is independent of the wear and tear of the conveyors used. As a result, the requirements for conveyors are lower, which can reduce maintenance costs.

With the tracking described, containers can be located not only when standing upright. Moreover, other container poses, such as different rotational positions, horizontal conveying or the like, can also be detected. The location information determined can then, for example, also include information on the orientation of the containers relative to the transport direction.

Since the containers are each captured in several images, position data derived therefrom may be interpolated when individual containers cannot be recognized and located in a particular image. In this way, location information could be determined for containers that are temporarily obscured by a crossbar or the like running through the imaging region, i.e. in terms of an interpolating reconstruction of position data or location information.

The at least one area sensor is in principle also suitable for monitoring several transport routes running alongside one another in the manner described, even if they run at different speeds or in opposite directions.

With the aid of the at least one area sensor, features of the containers can also be detected, such as the presence of a cap, the type of cap, the presence and/or orientation of an embossing and/or the container color.

With the at least one area sensor, different object types and/or situations would be distinguishable, such as a hand reaching into the container stream and/or toppled containers.

### BRIEF DESCRIPTION OF THE FIGURE

A preferred embodiment of the disclosure is illustrated in the drawing. The single FIGURE shows a schematic plan view of the apparatus.

### DETAILED DESCRIPTION

As can be seen in the FIGURE, the apparatus 1 for individually tracking containers B1 to B15 comprises a container tracking section 2, along which the containers B1 to B15 are transported in an unsorted manner in multiple lanes, for example, by a first transport means 3a and in a sorted manner in a single lane by a second and third transport means 3b, 3c.

During transport the containers B1 to B15, which are, for example, bottles or cans, can stand freely on the transport means 3a, 3b, 3c, i.e. without individual positive guidance of the containers B1 to B15.

The transport means 3a, 3b, 3c optionally run continuously during production. However, this is not mandatory for the method described.

For tracking the containers B1 to B15, the apparatus 1 comprises a stationary imaging region 4 of at least one surface-imaging sensor 5 for imaging the containers B1 to B15 on the container tracking section 2 in an ordered sequence of images 6.

In the example shown, the at least one surface-imaging sensor 5 is formed by three cameras 5a, 5b, 5c, the imaging regions 4a, 4b, 4c of which partially overlap and complement each other to form the stationary imaging region 4. Accordingly, the first camera 5a delivers first camera images 6a with the containers present in the first imaging region 4a (here B10 to B15) in a known chronological sequence, the second camera 5b delivers second camera images 6b with the containers present in the second imaging region 4b (here B6 to B10) in a known chronological sequence, and the third camera 5c delivers third camera images 6c with the containers present in the third imaging region 4c (here B1 to B6) in a known chronological sequence.

It should be appreciated, however, that the configuration of the surface-imaging sensor 5 in the form of the first to third cameras 5a, 5b, 5c and the combination of the stationary imaging region 4 from the first to third imaging regions 4a, 4b, 4c are merely exemplary and optional. It could also be just a single, suitably arranged camera 5a, 5b or 5c or a similar surface-imaging sensor 5 and a single imaging region 4a, 4b or 4c. Likewise, individual imaging regions 4a, 4b, 4c of the imaging region 4 do not have to overlap, but could also be directly adjacent to one another or arranged at a suitable distance from one another.

The images 6, here in the form of the first to third camera images 6a, 6b, 6c, are each created, for example, at an image recording rate of 5 to 40 images per second.

The apparatus 1 comprises at least one electronic evaluation unit 7 for evaluating the images 6 or camera images 6a, 6b, 6c. The evaluation unit 7 is configured to locate and identify individual containers B1 to B15 in the images 6. For this purpose, algorithms that are known in principle and/or a neural network can be implemented in the evaluation unit 7. The evaluation unit 7 evaluates individual images 6 or camera images 6a, 6b, 6c and optionally also compares images 6 or camera images 6a, 6b, 6c with each other.

The electronic evaluation unit 7 extracts individual tracking data TD1 to TD15 from the images 6 or camera images 6a, 6b, 6c, which are individually assigned to the individual containers B1 to B15 at least during their stay in the container tracking section 2. The electronic evaluation unit 7 may include a processor and memory including instructions for carrying out the operations as described herein, as well as the storing the information described herein.

The tracking data TD1 to TD15 each comprise at least identification information 8 for identifying the individual containers B1 to B15 and location information 9 relating to a sequence of locations and associated stay times of the individual containers B1 to B15 within the container tracking section 2.

The location information 9 can, for example, comprise a sequence of, in particular, two-dimensional location coordinates and associated stay times, which are, for example, the recording times of those images 6 (or camera images 6a, 6b, 6c) from which the location coordinates of the containers B1 to B15 are extracted. In principle, however, it would also be conceivable to extract only one-dimensional location coordinates, for example in case of single-lane container transport along a (then usually) fixed transport direction.

The location information 9 can also be calculated by interpolation or extrapolation of image data or the location coordinates extracted therefrom and the associated recording times. Extrapolated location information 9 can, for example, relate to an insufficiently visible location of the containers B1 to B15 which is at a suitable distance outside the stationary imaging region 4, for example immediately downstream thereof. On this basis, for example, an inspection sensor (not shown) that is optically shielded from the stationary imaging region 4 could be triggered.

The individual tracking data TD1 to TD15 make it possible to individually locate the containers B1 to B15, which are for example bottles or cans, during their transport through a filling plant 100 or similar plant for producing, treating and/or packaging the containers B1 to B15 and optionally also to follow them back along their production path.

As shown by way of example, the container tracking section 2 comprises an entry region 2a in which the containers B1 to B15 are taken over, for example, by another, upstream container tracking section 2, a transport means 20 that positively guides the containers B1 to B15 or a positively guiding process unit 30 (in each case not shown in the FIGURE), and an exit region 2b, from which the containers B1 to B15 are transferred, for example, to another, downstream container tracking section 2, to a positively guiding transport means 20 or to a process unit 30 (also not shown in the FIGURE).

Inspection sensors (not shown) for inspecting the containers B1 to B15 and/or container manipulators, for example for the targeted discharge of individual containers B1 to B15, can be arranged in the region of the container tracking section 2.

In the example shown, the containers B1 to B15 are distributed at a transfer point 10 by a guide element 11, which laterally deflects the containers B1 to B15, from the first transport means 3a, which herein is a belt-type conveyor for unsorted mass transport, optionally to the second or third transport means 3b, 3c, which herein are, for example, belt-type conveyors for single-lane sorted container transport, such as link chains or the like.

Here, the optional integration of the transfer point 10 with the guide element 11 is intended to illustrate that the movements of the containers B1 to B15 along the container tracking section 2 can differ in terms of direction and speed from the movements of the conveyors 3a, 3b, 3c without thereby affecting the container tracking described.

Instead, the described apparatus 1 operates mainly independently of the drive parameters of the individual conveyors 3a, 3b, 3c. This means that no actual drive data of the conveyors 3a, 3b, 3c are required to extract the tracking data TD 1 to TD15, such as the transmission of path increments or the like. However, such data could optionally be additionally taken into account in the electronic evaluation unit 7.

The transfer point 10 shown is also intended to illustrate that the described apparatus 1 and the method carried out therewith for tracking the containers B1 to B15 are in principle possible in any transport sections in which the transported containers B1 to B15 can be suitably viewed by at least one surface-imaging sensor 5. In principle, it does not matter then whether circumstances arise which lead to a deviation of the container movements from the movements of the respective associated transport means 3a, 3b, 3c.

For example, tracking of the containers B1 to B15 in terms of the present disclosure is also possible under dynamic pressure, in curves and during sudden decelerations and/or changes of direction (not shown), as well as in the case of unsorted mass transport and/or stationary guide elements 11 leading laterally to the containers B1 to B15.

Consequently, resynchronization of the container stream to be monitored with the associated transport means 3a, 3b, 3c, for example by light barriers, is not necessary.

The at least one area-imaging sensor 5 or the cameras 5a, 5b, 5c could in principle be placed in different ways and, depending on the installation space available, above the container stream to be monitored (here symbolized by block arrows). Here, the cameras 5a, 5b, 5c are shown next to the transport means 3a, 3b, 3c only for the sake of clarity. It would be equally conceivable to image the container tracking section 2 shown from diagonally above the transport means 3a, 3b, 3c with just a single area-imaging sensor 5, for example one of the cameras 5a, 5b, 5c, in such a way that suitable images 6 can be created and processed in the electronic evaluation unit 7 in order to extract the tracking data TD1 to TD15.

Due to the described extraction of the individual tracking data TD1 to TD15 the locations and associated stay times of the individual containers B1 to B15 within the container tracking section 2 can be predicted substantially independently of the transport movements of the transport means 3a, 3b, 3c used, for example in order to trigger inspection sensors (not shown) and/or actuators of container manipulators, for example for targeted container discharge (not shown).

The tracking data TD1 to TD15 can be updated over several container tracking sections 2 (monitored, as described) while maintaining their identity. An individual data transfer is possible from an upstream and/or to a downstream container tracking section 2 (not shown in the FIGURE) to or from the evaluation unit 7. This also makes it possible to trace individual containers B1 to B15 at least as far as the entry region 2a of the container tracking section 2 and, if necessary, also further to upstream container tracking sections 2 or, in particular, to positively guiding transport means 20 or process units 30.

An identity-preserving data transfer of location information 9 of the containers B1 to B15 is thus possible from an upstream processing unit 30 (not shown in the FIGURE) for the in particular positively guided processing of the containers B1 to B15 (e.g. during neck handling) to the evaluation unit 7 and/or from the evaluation unit 7 to a downstream processing unit 30 (not shown in the FIGURE). In principle, this also applies to input-side and/or output-side interfaces of the container tracking section 2 with other, in particular positively guided, transport means 20 (not shown in the FIGURE), such as transfer starwheels.

This makes possible a basically continuous tracking of individual containers B1 to B15 along a production path in a plant 100 of the type described above. It also makes possible a corresponding tracking of individual containers B1 to B15 along cascaded container tracking sections 2, transport means 20 and/or process units 30 for the purpose of quality assurance.

For this purpose, the tracking data TD1 to TD15 can be stored, for example, in the evaluation unit 7 or externally or centrally at another location and kept available for corresponding data evaluations for individual container tracking.

The invention claimed is:

1. A method for tracking containers in a filling plant or similar plant for producing and/or packaging the containers, wherein the containers are transported through a stationary imaging region of at least one surface-imaging sensor, which jointly images several containers in time-staggered images, wherein the images are evaluated electronically and whereby tracking data individually assigned to the containers are extracted, which at least comprise: identification information for identifying the respective container; and location information about a sequence of locations and associated stay times of the respective container.

2. The method according to claim 1, wherein the stationary imaging region is assigned to a container tracking section, the tracking data indicate the identity as well as the locations and stay times of the respective container at least for one entry region and one exit region of the container tracking section and the tracking data are stored.

3. The method according to claim 1, wherein the tracking data are extracted by identifying and locating the respective container in at least 10 of the images.

4. The method according to claim 1, wherein the containers are transported standing upright within the stationary imaging region on at least one transport means as follows: in the form of an unsorted mass transport; under dynamic pressure; along an incline, a decline and/or a curve; and/or along a guide element which laterally guides and/or deflects the containers in a stationary arrangement.

5. The method according to claim 1, wherein the containers change within the stationary imaging region from a first transport means to at least one second transport means.

6. The method according to claim 1, wherein the images are created in the form of camera images in recording cycles with an image recording rate of 5-40 images per second.

7. The method according to claim 1, wherein at least one inspection sensor arranged on a container tracking section and/or immediately adjacent thereto is triggered for inspecting the containers.

8. An apparatus for tracking containers, in a filling plant, comprising: at least one area-imaging sensor with a stationary imaging region for jointly imaging several of the containers during their transport in images offset from one another in time; an electronic evaluation unit which is configured to extract tracking data of individual containers from the images and to assign them individually to the containers, wherein the tracking data comprise identification information for identifying the respective container and location information about a sequence of locations and associated stay times of the respective container.

9. The apparatus according to claim 8, wherein the stationary imaging region is assigned to a container tracking section and the evaluation unit is configured to extract the tracking data in such a way that the identity as well as the locations and stay times of the respective container can be specified.

10. The apparatus according to claim 8, wherein the evaluation unit is configured to extract the tracking data by identifying and locating the respective container in at least 10 of the images.

11. The apparatus according to claim 8, wherein the at least one area-imaging sensor is directed at at least one transport means which is configured for the standing transport of the containers in an unsorted mass transport, under dynamic pressure, along an incline, a decline and/or a curve, and/or along a guide element which laterally guides and/or deflects the containers in a stationary arrangement.

12. The apparatus according to claim 8, wherein the at least one area-imaging sensor is directed at a transfer point via which the containers change from a first transport means to at least a second transport means.

13. The apparatus according to claim 8, wherein the at least one area-imaging sensor is configured to create the images in recording cycles with an image recording rate of 5-40 images per second.

14. A plant for producing and/or packaging containers and/or filling the containers, comprising: the apparatus according to claim 8 and at least one transport means for the standing transport of the containers through the stationary imaging region.

15. The plant according to claim 14, wherein the following are arranged upstream and/or downstream of the apparatus: another apparatus with the elements of the apparatus; a transport means for positively guiding the containers; and/or a process unit for positively guiding the containers for producing, treating, filling or packaging the containers.

16. The plant according to claim 14, wherein the plant comprises at least one inspection sensor for inspecting the containers and/or an actuator for manipulating the containers for their individual discharge, arranged on a container tracking section of the apparatus or immediately adjacent thereto, and is configured to trigger the inspection sensor when the containers are at a predetermined recording position with respect to the inspection sensor and/or the actuator when individual containers are at a discharge position, on the basis of the tracking data.

17. The method according to claim 1, wherein the containers include bottles or cans.

18. The method according to claim 2, wherein the tracking data are stored in a traceable manner.

19. The method according to claim 5, wherein the containers change within the stationary imaging region from the first transport means to the at least one second transport means via a transfer point running transversely to the transport means.

20. The method according to claim 7, wherein the at least one inspection sensor is triggered for inspecting the containers, when the containers are at a predetermined recording position with respect to the inspection sensor; wherein at least one actuator for container manipulation is provided for discharging individual containers, the at least one actuator being controlled when individual containers are at a predetermined discharge position on the basis of the tracking data.
